(19) United States
(12) Patent Application Publication
(10) Pub. No.: US 2015/0029131 A1
(43) Pub. Date: Jan. 29, 2015

(54) METHODS AND APPARATUSES FOR RECOGNIZING MULTIPLE FINGERS ON CAPACITIVE TOUCH PANELS AND DETECTING TOUCH POSITIONS

(71) Applicant: Solomon Systech Limited, Hong Kong (HK)

(72) Inventors: Wai Kin CHENG, Hong Kong (HK); Wing Chi Stephen CHAN, Hong Kong (HK); Wai Pak CHOI, Hong Kong (HK)

(73) Assignee: Solomon Systech Limited, Hong Kong (HK)

(21) Appl. No.: 13/958,622

(22) Filed: Aug. 5, 2013

(30) Foreign Application Priority Data
Jul. 24, 2013 (CN) 201310314837.9

(51) Int. Cl. G06F 3/041; G06F 3/044

(52) U.S. Cl. CPC G06F 3/0416; G06F 3/044
USPC 345/174

(57) ABSTRACT

A method is provided for recognizing touches by at least a finger on a touch panel and determining positions of the touches by analyzing a change in capacitance of electrodes of the touch panel. The change in capacitance is represented as at least an array. A digital signal processing unit and a touch panel that implement the method are also provided.

### CROSS REFERENCE TO RELATED PATENT APPLICATIONS

The present application claims benefit of Chinese patent application No. 201310314837.9, which filed on Jul. 24, 2013, the entire contents of which are hereby incorporated by reference.

### FIELD OF THE PATENT APPLICATION

The present patent application generally relates to touch panel technologies and more specifically to a method for recognizing finger touches on a touch panel and determining positions of the finger touches.

### BACKGROUND

Electronic devices such as mobile phones and portable computers often include a touch panel as an input device. One type of such touch panel is the capacitive touch panel. This type of touch panel is typically formed by an array of electrodes. The material of the electrodes can be any conductors. Typically, ITO is used when the touch panel is on top of a display system, because ITO is transparent. If transparency is not required, copper is typically used. When one or more human fingers approach or touch a capacitive touch panel, the capacitance of the electrodes will be changed. The positions of the touch can be calculated by collecting the capacitance-related information and analyzing them. There are many ways to obtain such information from the array of electrodes, but in general, electronic circuits are built to measure either the self-capacitance of the electrodes, or the mutual capacitance among the electrodes. Preferably, the capacitance information passes through a filtering circuit to eliminate any undesirable environmental noise. Afterwards, the capacitance information is transferred to a memory device for temporarily storage and ready for further processing. The capacitance information can be stored either as two one-dimensional arrays by projecting the capacitance information on the electrodes to two orthogonal axes, or as a two-dimension array directly.

Certain techniques are required to analyze the capacitance information. First, a finger recognition method is required to recognize multiple of finger touches from the array of capacitance information. This method should be able to distinguish between real finger touches and some undesired information caused by noises and interferences. In addition, this method should be able to distinguish the capacitance information corresponding to different fingers so that more than one finger touch can be recognized for the flexibility of the user interface. Second, a resolution enhancement method is required to calculate the actual touch positions. A main processing unit of the electronic device typically requires a much higher resolution than the dimension of the capacitance touch panel. A resolution enhancement method can make use of the capacitance information at each point to produce high resolution coordinates of touch positions.

Moreover, due to the trend of decreasing in size of modern electronic devices, it is beneficial to implement the capacitive touch panel control system into a compact Application Specific Integrated Circuit (ASIC), where the above methods are handled by dedicated Very Large Scale Integrated (VLSI) hardware logic circuits instead of a microprocessor. Therefore, the methods should be designed to facilitate VLSI hardware logic circuits implementation.

### SUMMARY

The present patent application is directed to a method for recognizing touches by at least a finger on a touch panel and determining positions of the touches by analyzing a change in capacitance of electrodes of the touch panel, the change in capacitance being represented as at least an array. In one aspect, the method includes: scanning the elements of the at least one array for a predetermined number of cycles; comparing each of the elements with elements adjacent thereto in each cycle; colonizing a plurality of the elements to a colony based on the comparison; validating the colony by comparing properties of the colony with a predetermined set of threshold values; calculating a colony size by counting number of elements in the colony; calculating a mixing ratio based on colony size for each validated colony; forming a fitting array that includes the maximum element in the colony and elements adjacent to the maximum element; calculating a plurality of coefficients for a curve or a surface that fits the fitting array with a minimized mean squared error; determining first positions of the touches with the coefficients; forming a weighted average array that includes colonized elements; calculating moments of mass and mass of the weighted average array; determining second positions of the touches by dividing the moments of mass by the mass; and determining hybrid positions of the touches based on the first positions, second positions and the mixing ratio so that the resolution of the determined positions is higher than the physical resolution of the touch panel.

The change in capacitance may be represented as two one-dimensional arrays while the scanning may be carried out to each one-dimensional array in a forward direction and in a backward direction during alternating cycles. Each element in each one-dimensional array may be compared with two elements adjacent thereto in a predetermined order at different scan directions. A plurality of elements in each one-dimensional array may be grouped into a colony based on the comparison, and thereby a plurality of colonies is formed. The properties of the colony being compared with the predetermined set of threshold values may include the maximum value of the elements in the colony, the number of elements of the colony, and the sum of values of all the elements of the colony. The step of validating the colony may include eliminating the colony if the properties of the colony fail to meet the predetermined set of threshold values.

The change in capacitance may be represented as a two-dimensional array while the scanning is carried out to the two-dimensional array in a forward direction and in a backward direction during alternating cycles. Each element in the two-dimensional array may be compared with eight elements adjacent thereto in a predetermined order at different scan directions. A plurality of elements in the two-dimensional array may be grouped into a colony based on the comparison, and thereby a plurality of colonies is formed. The properties of the colony being compared with the predetermined set of threshold values may include the maximum value of the elements in the colony, the number of elements of the colony, and the sum of values of all the elements of the colony. The step of validating the colony may include eliminating the colony if the properties of the colony fail to meet the predetermined set of threshold values.

In calculating the coefficients, a fixed coordinate system may be applied to the elements in the fitting array so that a pseudo-inverse matrix becomes a constant. The elements in the pseudo-inverse matrix may be normalized into whole numbers. In determining the positions of the touches, one coefficient may be divided by another, thereby gaining resolution from the decimal precision of a divider that performs the division.

The mixing ratio may have a value between 0 and 1. Hybrid positions of the touches may be further determined by multiplying second positions with the mixing ratio, multiplying first positions with 1-mixing ratio and adding two products together.

In another aspect, the present patent application provides a digital signal processing unit that includes logical circuits configured for recognizing touches by at least a finger on a touch panel and determining the positions of the touches by analyzing a change in capacitance of electrodes of the touch panel, the change in capacitance being represented as at least an array. The logical circuits include: means for scanning the elements of the at least one array for a predetermined number of cycles; means for comparing each of the elements with elements adjacent thereto in each cycle; means for colonizing a plurality of the elements to a colony based on the comparison; means for validating the colony by comparing properties of the colony with a predetermined set of threshold values; means for calculating a colony size by counting number of elements in the colony; means for calculating a mixing ratio based on colony size for each validated colony; means for forming a fitting array that includes the maximum element in the colony and elements adjacent to the maximum element; means for calculating a plurality of coefficients for a curve or a surface that fits the fitting array with a minimized mean squared error; means for determining first positions of the touches with the coefficients; means for forming a weighted average array that includes colonized elements; means for calculating moments of mass and mass of the weighted average array; means for determining second positions of the touches by dividing the moments of mass by the mass; and means for determining hybrid positions of the touches based on the first positions, second positions and the mixing ratio so that the resolution of the determined positions is higher than the physical resolution of the touch panel.

The change in capacitance may be represented as two one-dimensional arrays while the logical circuits include means for carrying out the scanning to each one-dimensional array in a forward direction and in a backward direction during alternating cycles, and means for comparing each element in each one-dimensional array with two elements adjacent thereto in a predetermined order at different scan directions.

The change in capacitance may be represented as a two-dimensional array while the logical circuits include means for carrying out the scanning to the two-dimensional array in a forward direction and in a backward direction during alternating cycles, and means for comparing each element in the two-dimensional array with eight elements adjacent thereto in a predetermined order at different scan directions.

In yet another aspect, the present patent application provides a touch panel that includes: a plurality of electrodes configured to sense touches of at least a finger on the touch panel; and a digital signal processing unit configured for recognizing the touches and determining the positions of the touches by analyzing a change in capacitance of the electrodes, the change in capacitance being represented as at least an array. The digital signal processing unit includes logical circuits that include: means for scanning the elements of the at least one array for a predetermined number of cycles; means for comparing each of the elements with elements adjacent thereto in each cycle; means for colonizing a plurality of the elements to a colony based on the comparison; means for validating the colony by comparing properties of the colony with a predetermined set of threshold values; means for calculating a colony size by counting number of elements in the colony; means for calculating a mixing ratio based on colony size for each validated colony; means for forming a fitting array that includes the maximum element in the colony and elements adjacent to the maximum element; means for calculating a plurality of coefficients for a curve or a surface that fits the fitting array with a minimized mean squared error; means for determining first positions of the touches with the coefficients; means for forming a weighted average array that includes colonized elements; means for calculating moments of mass and mass of the weighted average array; means for determining second positions of the touches by dividing the moments of mass by the mass; and means for determining hybrid positions of the touches based on the first positions, second positions and the mixing ratio so that the resolution of the determined positions is higher than the physical resolution of the touch panel.

In calculating the coefficients, the logical circuits include means for applying a fixed coordinate system to the elements in the fitting array so that a pseudo-inverse matrix becomes a constant.

### BRIEF DESCRIPTIONS OF THE DRAWINGS

FIG. 1 is a block diagram of a capacitive touch panel system according to an embodiment of the present patent application.

FIG. 2 is a flow chart of a finger touch recognition method according to an embodiment of the present patent application.

FIG. 3 is a diagram showing a colonized one-dimensional array according to an embodiment of the present patent application.

FIG. 4 is a diagram showing a colonized two-dimensional array according to an embodiment of the present patent application.

FIG. 5 is a diagram showing a coordinate system assigned to a one-dimensional array of 3 elements according to an embodiment of the present patent application.

FIG. 6 is a diagram showing one preferable VLSI implementation of an embodiment of the present patent application.

FIG. 7 is a diagram showing a coordinate system assigned to a two-dimensional array of 9 elements according to an embodiment of the present patent application.

FIG. 8 is a diagram showing one preferable VLSI implementation according to an embodiment of the present patent application.

FIG. 9 illustrates a flow chart of a method for recognizing touches with resolution enhancement according to an embodiment of the present patent application.

### DETAILED DESCRIPTION

Reference will now be made in detail to a preferred embodiment of the method for recognizing finger touches on a touch panel and determining positions of the finger touches disclosed in the present patent application, examples of which are also provided in the following description. Exemplary embodiments of the method disclosed in the present patent application are described in detail, although it will be apparent to those skilled in the relevant art that some features that are not particularly important to an understanding of the method may not be shown for the sake of clarity.

Furthermore, it should be understood that the method for recognizing finger touches on a touch panel and determining positions of the finger touches disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

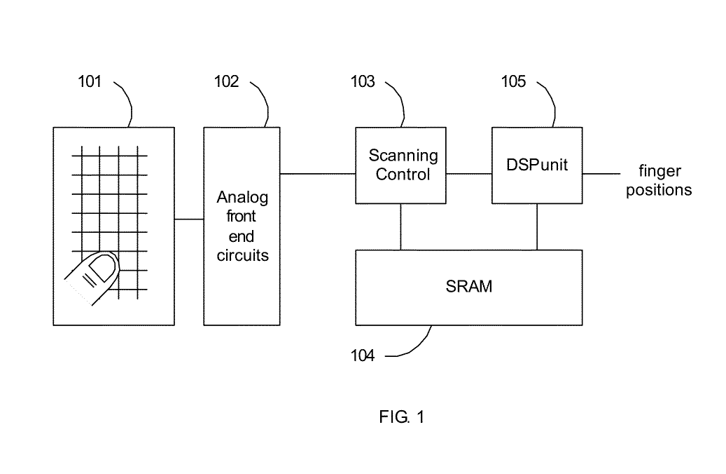

Referring to FIG. 1, a block diagram of a capacitive touch panel system according to an embodiment of the present patent application is shown. In this system, a capacitive touch panel 101 is directly connected to a block of analog front end circuits 102. The analog front end circuits 102 are configured for sending electrical signals to the capacitive touch panel 101 and sensing any response signals. Typically, an analog-to-digital converter (ADC) is included in the analog front end circuits 102 and configured to convert the response signals into a digital form of capacitance information. The scanning control unit 103 is configured for controlling the timing and the operation of a scanning process. The scanning control unit 103 also receives capacitance information from the analog front end circuits 102, and stores the capacitance information into a memory device 104. Preferably, a Static Random Access Memory (SRAM) is used as such a memory device. When the scanning process is completed, the scanning control unit 103 notifies the Digital Signal Processing (DSP) unit 105 to recognize fingers and calculates the corresponding touch positions if any fingers are present. The touch positions are then sent back to a host processor of an electronic device (also referred to as the host system hereafter) for further processing. To achieve compact size, the capacitive touch panel system described above is preferably implemented into a single ASIC (application-specific integrated circuit) by VLSI (very-large-scale integration) process. The logical circuits within the DSP unit 105 and the method implemented by the logical circuits are described hereafter in more detail.

Depending on the methodology of scanning being employed, the capacitance information can be stored into the memory device 104 in different arrangements. Two different arrangements of capacitance information inside the memory device 104 can be used. In one embodiment of the present patent application, it is assumed that the capacitance information is stored as two one-dimensional arrays. Such an arrangement, which is referred to as the type A arrangement hereafter, is formed when the capacitive touch panel is scanned on the x-axis and the y-axis separately. In the type A arrangement, the projected capacitance on the x-axis and the projected capacitance on the y-axis are measured. In another embodiment of the present patent application, it is assumed that the capacitance information is stored as a two-dimensional array. Such an arrangement, which is referred to as the type B arrangement hereafter, is formed when the capacitive touch panel is scanned line-by-line. In this arrangement, the capacitance at each intersection point is measured.

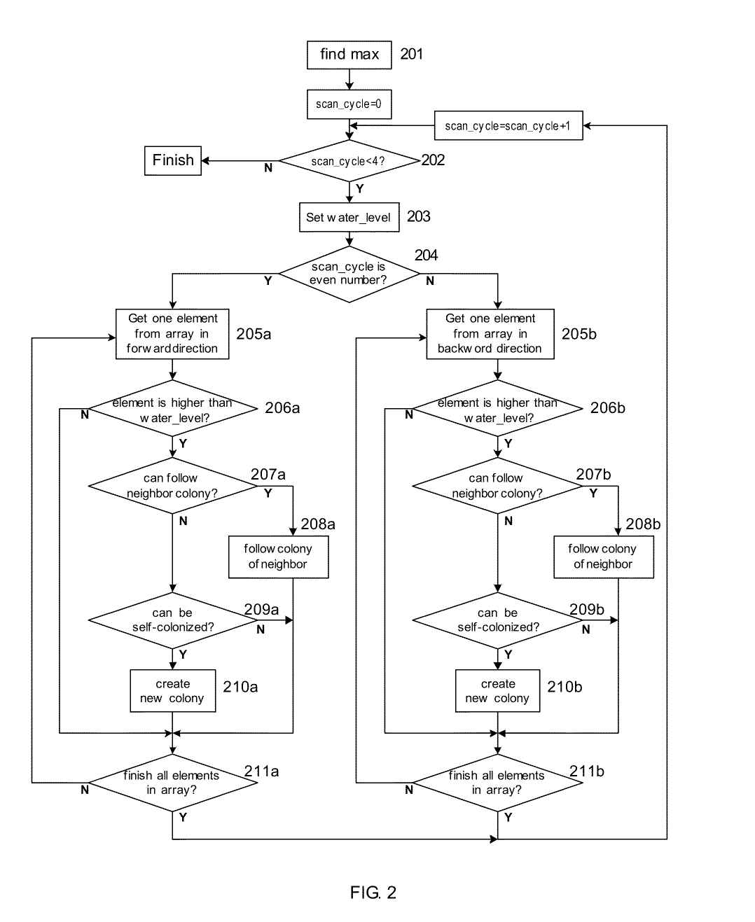

Referring to FIG. 2, a flow chart of a finger touch recognition method according to an embodiment of the present patent application is shown. The flow chart can be applied to both type A and type B arrangements mentioned above, while the operations of some individual steps are different between the different types. In this embodiment, a method for recognizing touches by at least a finger on a touch panel and determining the positions of the touches by analyzing a change in capacitance of electrodes of the touch panel is provided. The change in capacitance is represented as at least an array. The method includes: scanning the elements of the at least one array for a predetermined number of cycles; comparing each of the elements with elements adjacent thereto in each cycle; colonizing a plurality of the elements to a colony based on the comparison; and validating the colony by comparing properties of the colony with a predetermined set of threshold values.

More specifically, referring to FIG. 2, for the type A arrangement, the finger touch recognition process is carried out on each one-dimensional array separately. In step 201, the maximum element in a one-dimensional array is found by searching through the array. The value of the maximum element in the one-dimensional array is then stored in a separate storage space, for example, a register, for further processing. The following procedure includes an iterative process of scanning the one-dimensional array. The number of iterations can be any integer number, but is preferably set to 4 in this embodiment for the balance between the processing time and the performance. Initially, a scan cycle number is assigned as 0. This number is incremented by 1 after each scan cycle. In step 202, the scan cycle number is checked for whether it is less than 4 or not. If the answer is yes, the process continues; if else, the process terminates. In step 203, a variable WATER_LEVEL is re-assigned at the start of each scan cycle. If the scan cycle number is 0, WATER_LEVEL is set to a fraction of the maximum element in the one-dimensional array. If the scan cycle number is larger than 0, WATER_LEVEL is set to a fraction of itself in the previous scan cycle. The fraction number can be any real number between 0 and 1. The fraction number can also be changed in every scan cycle. Preferably, the fraction number is set to 0.75 in this embodiment. In step 204, the scan cycle number is checked for whether it is odd or even. If the scan cycle number is even, the one-dimensional array is scanned in a forward direction as in step 205a. If the scan cycle number is odd, the one-dimensional array is scanned in a backward direction as in step 205b. For each element in the array, steps 206a to 210a are carried out if the scan is in the forward direction, and steps 206b to 210b are carried out if the scan is in the backward direction.

Each element is checked for whether it is larger than WATER_LEVEL in steps 206a and 206b. If the element is larger than WATER_LEVEL, further processing is carried out in step 207a or 207b according to the scan direction. Otherwise, the process goes to step 211a or 211b according to the scan direction.

A process called colonization is carried out in steps 207a to 210a and in steps 207b to 210b. The purpose of this process is to group elements into a number of colonies through a number of iterative scanning processes. Each colony corresponds to a possible finger touch. An integer number COLONY(n) is associated with each element in the array, wherein the integer number n is the index of an element in the array. If COLONY(n) is 0, it means that element(n) is not colonized. If COLONY(n) is larger than 0, it means that element(n) is colonized, and the value of COLONY(n) represents the group of the colony that element(n) belongs to.

Each element is first checked for the possibility to follow the colony of its neighborhood. The checking process in a forward scan is different from the checking process in a backward scan. Steps 207a and 208a correspond to the checking process in the forward scan. In step 207a, COLONY(n+1) is checked first. If COLONY(n+1) is not zero, then element(n+1) is compared with element(n). If element(n) is smaller than or equal to element(n+1), then COLONY(n) is assigned with the value of COLONY(n+1) in step 208a. If COLONY(n+1) is zero or element(n) is larger than element(n+1), then the process continues in step 207a, wherein COLONY(n−1) is checked. If COLONY(n−1) is non-zero, then element(n−1) is compared with element(n). If element(n) is smaller than or equal to element(n−1), then COLONY(n) is assigned with the value of COLONY(n−1) in step 208a. Steps 207b and 208b correspond to the checking process in the backward scan. Steps 207b and 208b are similar to steps 207a and 208a, except that element(n−1) and COLONY(n−1) are checked first, followed by element(n+1) and COLONY(n+1). The comparison logics in steps 207a and 208a can be represented by the pseudo-code in code 1. The comparison logics in steps 207b and 208b can be represented by the pseudo-code in code 2.

Code 1:

```
IF (COLONY(n+1) > 0) AND (element(n) <= element(n+1)) THEN
      ASSIGN COLONY(n) WITH COLONY(n+1)
ELSE IF (COLONY(n−1) > 0) AND (element(n) <= element(n−1)) THEN
      ASSIGN COLONY(n) WITH COLONY(n−1)
```

Code 2:

```
IF (COLONY(n−1) > 0) AND (element(n) <= element(n−1)) THEN
      ASSIGN COLONY(n) WITH COLONY(n−1)
ELSE IF (COLONY(n+1) > 0) AND (element(n) <= element(n+1)) THEN
      ASSIGN COLONY(n) WITH COLONY(n+1)
```

If element(n) cannot be colonized according to the condition in step 207a or 207b, the process checks whether a new colony can be formed in step 209a or 209b according to the scan direction. In step 209a, element(n) is compared with element(n−1) and element(n+1). If element(n) is strictly larger than element(n+1), while larger than or equal to element(n−1), a new colony is created in step 210a, and COLONY(n) is assigned with a new colony number NEW_COLONY, which does not exist before. In step 209b, element(n) is also compared with element(n−1) and element(n+1). If element(n) is strictly larger than element(n−1), while larger than or equal to element(n+1), a new colony is created in step 210b, and COLONY(n) is assigned with a new colony number NEW_COLONY, which does not exist before. Steps 209a and 210a can be represented by the pseudo-code in code 3. Steps 209b and 210b can be represented by the pseudo-code in code 4.

Code 3:

IF (element(n) > element(n+1)) AND (element(n) >= element(n−1))
THEN
ASSIGN COLONY(n) WITH NEW_COLONY

Code 4:

IF (element(n) > element(n−1)) AND (element(n) >= element(n+1))
THEN
ASSIGN COLONY(n) WITH NEW_COLONY

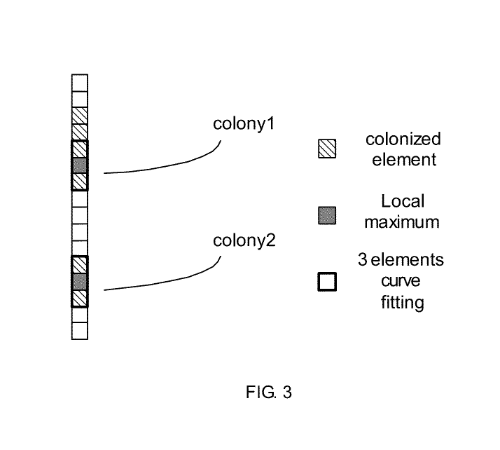

In steps 211a and 211b, the process checks whether one scan cycle is finished. If the last element in the array has been checked, the process goes back to step 202 to check whether 4 scan cycles has been completed. Otherwise, the process goes back to step 205a or 205b according to the scan direction, where the next element in the array is fetched for checking. When 4 scan cycles have been completed, the colonization process completes. Elements with a non-zero value of COLONY(n) are colonized. Groups of elements with the same non-zero value of COLONY(n) belongs to the same colony, while each of such colony represents a possible finger touch. Referring to FIG. 3, a colonized one-dimensional array is shown. The shaded areas represent the colonized elements. As an example, two colonies are shown in FIG. 3. The maximum number of colonies depends on various parameters such as the size of the array and the characteristics of the capacitive touch panel, and is not limited by the colonization process.

Subject to the background noise or the non-uniformity of the capacitive touch panel, the colonies may not represent an actual finger touch. Using the unfiltered colonization information for further processing may produce invalid touch positions, and thus trigger some incorrect events in the host system. Therefore, the embodiment of the present patent application includes a validation process to validate the colonized capacitance information.

For each colonies, several properties are obtained, including the maximum value COLONY_PEAK(j) of each colony, the total number of elements COLONY_AREA(j) of each colony, and the sum of values of all the elements COLONY_WEIGHT(j) of each colony. For any colony j, if COLONY_MAX(j) is larger than a threshold value MIN_LEVEL, if COLONY_AREA(j) is larger than a threshold value MIN_AREA, and if COLONY_WEIGHT(j) is larger than a threshold value MIN_WEIGHT, then colony j is validated as a finger touch. Only validated colonies are passed to the host processor for further processing.

In the above embodiment, the change in capacitance is represented as two one-dimensional arrays while the scanning is carried out to each one-dimensional array in a forward direction and in a backward direction during alternating cycles. Each element in each one-dimensional array is compared with two elements adjacent thereto in a predetermined order at different scan directions. A number of elements in each one-dimensional array are grouped into a colony based on the comparison, and thereby a number of colonies are formed. The properties of the colony being compared with the predetermined set of threshold values include the maximum value of the elements in the colony, the number of elements of the colony, and the sum of values of all the elements of the colony. The step of validating the colony includes eliminating the colony if the properties of the colony fail to meet the predetermined set of threshold values.

For the type B arrangement, according to another embodiment of the present patent application, the capacitance information is stored as a two-dimensional array. Similar to the previous embodiment, the method for finger recognition illustrated in FIG. 2 can also be applied, except that the operations in some steps are modified. Referring to FIG. 2, in step 201, the maximum element is found by searching through the two-dimensional array. Step 202 is the same as that in the previous embodiment, where the scan cycle number is checked for whether it is larger than 4. Similarly, steps 203 and 204 are also same as those in the previous embodiment.

In steps 205a and 205b for this embodiment, the definition of the forward scan and the backward scan is refined because the capacitance information array is two-dimensional. In step 205a, the first element in the first row is scanned first, followed by the second element in the first row. When all of the elements in the first row are scanned, the elements in the second row are scanned in the same order. The process continues in the same way until all of the elements in the last row are scanned. In step 205b, the last element in the last row is scanned first, followed by the second last element in the last row. When all of the elements in the last row are scanned, the elements in the second last row are scanned in the same order. The process continues in the same way until all of the elements in the first row are scanned. Steps 206a and 206b are the same as those in the previous embodiment.

In this embodiment, an integer number COLONY(m,n) is associated with each element in the two-dimensional array, where m is the row index of the element, and n is the column index of the element. If COLONY(m, n) is 0, it means that element(m,n) is not colonized. If COLONY(m, n) is larger than 0, it means that element(m,n) is colonized, and the value of COLONY(m, n) represent the group of colony that element(m,n) belongs to.

In steps 207a and 207b for this embodiment, the conditions for an element(m,n) to follow neighboring colonies is different from those in the previous embodiment. In step 207a, element(m,n) is compared with its neighboring elements in the order of element(m+1, n), element(m, n+1), element(m−1, n), element(m, n−1), element(m+1, n+1), element(m−1, n+1), element(m−1, n−1), and element(m+1, n−1). In step 207b, element(m,n) is compared with its neighboring elements in the order of element(m−1, n), element(m, n−1), element(m+1, n), element(m, n+1), element (m−1, n−1), element(m+1, n−1), element(m+1, n+1), and element(m−1, n+1). In both steps of 207a, and 207b, an element(m,n) can follow its neighboring element's colony if it is smaller than or equal to the comparing element, and the comparing element is already colonized. In both steps of 208a and 208b, COLONY(m,n) of element(m,n) is assigned with the COLONY number of its neighboring elements if the conditions in 207a and 207b are matched respectively. The comparison logic in 207a and 208a can be represented by pseudo-code in code 5. The comparison logic in 207b and 208b can be represented by pseudo-code in code 6.

Code 5:

```
IF (COLONY(m+1, n) > 0) AND (element(m, n) <= element(m+1, n)) THEN
      ASSIGN COLONY(m,n) WITH COLONY(m+1,n)
ELSE IF (COLONY(m, n+1) > 0) AND (element(m, n) <= element(m, n+1)) THEN
      ASSIGN COLONY(m, n) WITH COLONY(m, n+1)
ELSE IF (COLONY(m−1, n)>0) AND (element(m,n) <= element(m−1,n)) THEN
      ASSIGN COLONY(m,n) WITH COLONY(m−1,n)
ELSE IF (COLONY(m, n−1)>0) AND (element(m,n) <= element(m, n−1)) THEN
      ASSIGN COLONY(m,n) WITH COLONY(m,n−1)
ELSE IF (COLONY(m+1, n+1)>0) AND (element(m,n) <= element(m+1, n+1)) THEN
      ASSIGN COLONY(m,n) WITH COLONY(m+1, n+1)
ELSE IF (COLONY(m−1, n+1)>0) AND (element(m,n) <= element(m−1, n+1)) THEN
      ASSIGN COLONY(m,n) WITH COLONY(m−1, n+1)
ELSE IF (COLONY(m−1, n−1)>0) AND (element(m,n) <= element(m−1, n−1)) THEN
      ASSIGN COLONY(m,n) WITH COLONY(m−1,n−1)
ELSE IF (COLONY(m+1, n−1)>0) AND (element(m,n) <= element(m+1, n−1)) THEN
      ASSIGN COLONY(m,n) WITH COLONY(m+1,n−1)
```

Code 6:

```
IF (COLONY(m−1, n) > 0) AND (element(m, n) <= element(m−1, n)) THEN
      ASSIGN COLONY(m,n) WITH COLONY(m−1,n)
ELSE IF (COLONY(m, n−1) > 0) AND (element(m, n) <= element(m, n−1)) THEN
      ASSIGN COLONY(m, n) WITH COLONY(m, n−1)
ELSE IF (COLONY(m+1, n)>0) AND (element(m,n) <= element(m+1,n)) THEN
      ASSIGN COLONY(m,n) WITH COLONY(m+1,n)
ELSE IF (COLONY(m, n+1)>0) AND (element(m,n) <= element(m, n+1)) THEN
      ASSIGN COLONY(m,n) WITH COLONY(m,n+1)
ELSE IF (COLONY(m−1, n−1)>0) AND (element(m,n) <= element(m−1, n−1)) THEN
      ASSIGN COLONY(m,n) WITH COLONY(m−1, n−1)
ELSE IF (COLONY(m+1, n−1)>0) AND (element(m,n) <= element(m+1, n−1)) THEN
      ASSIGN COLONY(m,n) WITH COLONY(m+1, n−1)
ELSE IF (COLONY(m+1, n+1)>0) AND (element(m,n) <= element(m+1, n+1)) THEN
      ASSIGN COLONY(m,n) WITH COLONY(m−1,n−1)
ELSE IF (COLONY(m−1, n+1)>0) AND (element(m,n) <= element(m−1, n+1)) THEN
      ASSIGN COLONY(m,n) WITH COLONY(m−1,+1)
```

In this embodiment, if element(m,n) cannot be colonized in step 207a or 207b, the process checks whether a new colony can be created in step 209a or 209b, according to the scan direction. In step 209a, element(m,n) is compared with all eight neighboring elements. If element(m,n) is strictly larger than element(m, n+1), element(m+1, n−1), element(m+1, n), and element(m+1, n+1), while larger than or equal to element(m, n−1), element(m−1, n−1), element(m−1,n), and element(m−1, n+1), a new colony is created in step 210a, and COLONY(m,n) is assigned with a new colony number NEW_COLONY, which does not exist before. In step 209b, element(m,n) is also compared with all eight neighboring elements. If element(m,n) is strictly larger than element(m, n−1), element(m−1, n−1), element(m−1,n), and element(m−1, n+1), while larger than or equal to element(m, n+1), element(m+1, n−1), element(m+1, n), and element(m+1, n+1), a new colony is created in step 210b, and COLONY(n) is assigned with a new colony number NEW_COLONY, which does not exist before. Steps 209a and 210a can be represented by the pseudo-code in code 7. Steps 209b and 210b can be represented by the pseudo-code in code 8.

Code 7:

IF (element(m, n) > element(m, n+1))
AND (element(m,n) > element(m+1, n−1))
AND (element(m,n) > element(m+1, n))
AND (element(m,n) > element(m+1, n+1))
AND (element(m,n) >= element(m, n−1))
AND (element(m,n) >= element(m−1, n−1))
AND (element(m,n) >= element(m−1, n))
AND (element(m,n) >= element(m−1, n+1)) THEN
ASSIGN COLONY(m, n) WITH NEW_COLONY

Code 8:

IF (element(m, n) >= element(m, n+1))
AND (element(m,n) >= element(m+1, n−1))
AND (element(m,n) >= element(m+1, n))
AND (element(m,n) >= element(m+1, n+1))
AND (element(m,n) > element(m, n−1))
AND (element(m,n) > element(m−1, n−1))
AND (element(m,n) > element(m−1, n))
AND (element(m,n) > element(m−1, n+1)) THEN
ASSIGN COLONY(m, n) WITH NEW_COLONY

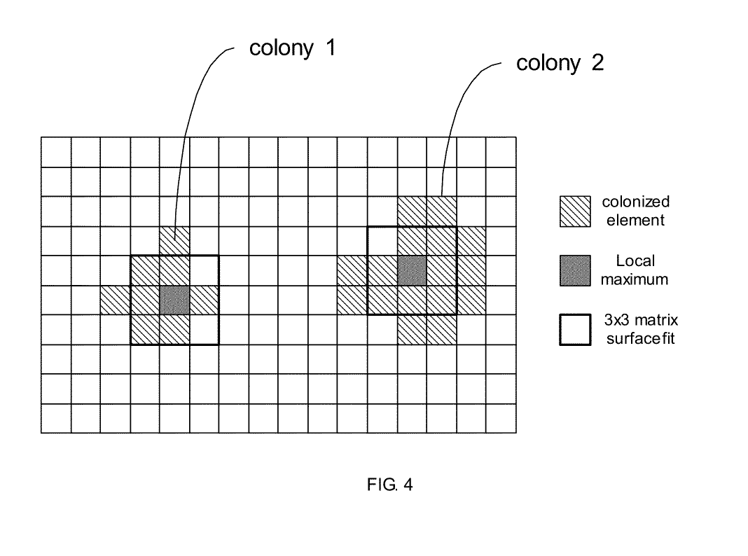

In steps 211a and 211b for this embodiment, the process checks whether one scan cycle is finished. If the last element in the array has been checked, the process goes back to step 202 to check whether 4 scan cycles have been completed. Otherwise, the process goes back to 205a or 205b according to the scan direction, where the next element in the array is fetched for checking. When 4 scan cycles have been completed, the colonization process has been completed. Elements with a non-zero value of COLONY(m, n) are colonized. Groups of elements with the same non-zero value of COLONY(m, n) belongs to the same colony, while each of such colony represents a possible finger touch. Referring to FIG. 4, a colonized two-dimensional array is shown. The shaded areas represent the colonized elements. As an example, two colonies are shown in FIG. 4. The maximum number of colonies depends on various parameters such as the size of the array and the characteristics of the capacitive touch panel, and is not limited by the colonization process.

Similar to the previous embodiment, the method for finger touch recognition in this embodiment includes a validation process after the colonization process is completed, which can effectively filter out some invalid colonies. For each colony, several properties are obtained, including the maximum value COLONY_PEAK(j) of each colony, the total number of elements COLONY_AREA(j) of each colony, and the sum of values of all elements COLONY_WEIGHT(j) of each colony. For any colony j, if COLONY_MAX(j) is larger than a threshold value MIN_LEVEL, if COLONY_AREA(j) is larger than a threshold value MIN_AREA, and if COLONY_WEIGHT(j) is larger than a threshold value MIN_WEIGHT, then colony j is validated as a finger touch. Only validated colonies are passed to the host processor for further processing.

In the above embodiment, the change in capacitance is represented as a two-dimensional array while the scanning is carried out to the two-dimensional array in a forward direction and in a backward direction during alternating cycles. Each element in the two-dimensional array is compared with eight elements adjacent thereto in a predetermined order at different scan directions. A number of elements in the two-dimensional array are grouped into a colony based on the comparison, and thereby a number of colonies are formed. The properties of the colony being compared with the predetermined set of threshold values include the maximum value of the elements in the colony, the number of elements of the colony, and the sum of values of all the elements of the colony. The step of validating the colony includes eliminating the colony if the properties of the colony fail to meet the predetermined set of threshold values.

In the above embodiments, each validated colony formed during the finger recognition process typically has a dome shaped profile. This is because every finger touch on a capacitive touch panel typically affects the capacitance of several electrodes. Capacitance of electrodes closer to the finger touch is more affected, while capacitance of electrodes further from the finger touch is less affected. A resolution enhancement method provided by another embodiment of the present patent application can be analogized to finding the peak position of the dome shaped profile. In the embodiment of the type A arrangement as aforementioned, wherein the capacitance information array is stored as two one-dimensional arrays, the resolution enhancement method applies the concept of curve fitting. In the embodiment of the type B arrangement as aforementioned, wherein the capacitance information array is stored as a two dimensional array, the resolution enhancement method applies the concept of surface fitting, which is a two-dimensional expansion of the curve fitting.

The concept of curve fitting provided in this embodiment has the following advantages. (1) Due to continuous variations in the background environment, the capacitance of the electrodes varies with time continuously. A method that solely considers the value of each element typically produces an unstable touch position, leading to undesired effects in the host system. Although the value of each element varies with time continuously, the overall profile of the dome shaped pattern caused by a finger touch does not change as much as the value of the elements. In such a case, curve fitting is a relatively more effective method in finding the touch position because the overall shape of the profile is considered. (2) The concept of curve fitting is not bounded by the absolute values of the elements. The values of the elements do not necessarily fit exactly on the curve for a successful curve fitting. Therefore, minor variations of the dome shape profile due to differences in the characteristics among different touch panels are not crucial to the accuracy of the touch positions obtained by curve fitting.

A typical method for curve fitting or surface fitting is too complicated for VLSI implementation. The following embodiments of the present patent application apply special conditions to the method, making it relatively simple for VLSI implementation.

In an embodiment of the present patent application, a method for determining the positions of the touches is provided. The method includes: forming a fitting array that includes the maximum element in the colony and elements adjacent to the maximum element; calculating a plurality of coefficients for a curve or a surface that fits the fitting array with a minimized mean squared error; and determining the positions of the touches with the coefficients so that the resolution of the determined positions is higher than the physical resolution of the touch panel. It is noted that a two-dimensional fitting array is essentially a fitting matrix.

More specifically, in this embodiment, a finger touch on a capacitive touch panel forms a dome shaped curve on a one-dimensional capacitance information array. As an example, a parabolic curve is chosen to fit the dome shaped curve. A typical parabolic curve can be described by the following equation:

z=A0−A1(x−A2)² eq. (1)

If all of the coefficients A0, A1, and A2 are positive numbers, equation (1) describes a general parabolic curve with a convex shape. A0 is the magnitude of the maximum point. A1 describes the falling rate of the parabola. A2 is the position of the maximum point. After fitting the parabolic curve and obtaining A2, the position of the finger touch can be found.

For the purpose of curve fitting, equation (1) has to be rearranged in general form as shown below:

Z=C0+C1x−C2x² eq. (2)

C0 is the zero order coefficient, C1 is the first order coefficient, and C2 is the second order coefficient. The negative sign of the second order term is consistent with the negative sign of A1 in equation (1), which indicates the convex shape of the parabola.

The first step of curve fitting is to collect all data points to be fitted into equation (2), and form the following matrixes:

$$Z = [ \begin{matrix}z 0 \\ z 1 \\ z 2\end{matrix} ] ; \\ B = [ \begin{matrix}1 & x 0 & - x {0}^{2} \\ 1 & x 1 & - x {1}^{2} \\ 1 & x 2 & - x {2}^{2}\end{matrix} ] ; \\ C = [ \begin{matrix}C 0 \\ C 1 \\ C 2\end{matrix} ] \qquad eq . ( 3 )$$

Matrix Z is a k-by-1 matrix, where k is the number of data points to be fitted. Each element in Z is the value of a data point. Matrix B, a k-by-3 matrix, is a fitting matrix, or in other words, a two-dimensional fitting array. Each row has three elements. The first element in a row is always a constant 1. The second element in a row is the position of the data point to be fitted. The third element in a row is the negative square of the position of the data point to be fitted. The number of rows in B is equal to the number of data points to be fitted. Matrix C is a 3-by-1 matrix, the elements of which are C0, C1 and C2.

In general, k can be any number larger than or equal to 3. In this embodiment, only 3 data points are used, and therefore only 3 data points are shown above.

Define a matrix E so that

E=Z−BC eq. (4)

The curve fitting problem is equivalent to finding a matrix C such that the Mean Squared Error (MSE) 1/nE^{T}E is minimal.

By substituting equation (4) into the MSE, and setting the derivative to 0, the desired C matrix can be found by the following equation:

C=[B^{T}B^{-A}B^{T}]Z eq. (5)

The matrix [B^{T}B⁻¹B^{T}] is called the pseudo-inverse of matrix B. Calculation of the pseudo-inverse inside a VLSI consumes a lot of processing power; and therefore it is avoided in this embodiment.

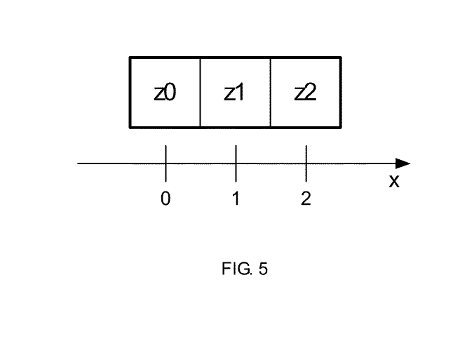

For each validated colony formed by the finger recognition process in the previous embodiment for the type A arrangement, the position of the maximum element COLONY_MAX(j) of each colony is stored as POS_REF for further processing. Referring to FIG. 3, for each validated colony, three elements are chosen for curve fitting, including the maximum element and its two adjacent elements. Referring to FIG. 5, these three data points are assigned with x-coordinate of [0, 1, 2]. Putting the x of these three data points into x0 to x2, B matrix can be rewritten as:

$$B = [ \begin{matrix}1 & 0 & 0 \\ 1 & 1 & - 1 \\ 1 & 2 & - 4\end{matrix} ] \qquad eq . ( 6 )$$

B matrix becomes a constant. The pseudo-inverse can be calculated as below:

$$[ {B}^{T} {B}^{- 1} {B}^{T} ] = [ \begin{matrix}1 & 0 & 0 \\ - 1.5 & 2 & - 0.5 \\ - 0.5 & 1 & - 0.5\end{matrix} ] \qquad eq . ( 7 )$$

Therefore according to equation (5), C can be calculated by:

C0=z0 eq. (8)

C1=−1.5z0+2z1−0.5z2 eq. (9)

C2=−0.5z0+z1−0.5z2 eq. (10)

By comparing Equation (1) and (2), A2 is equal to C1/2C2. Along with equations (9) and (10), it gives:

$$A 2 = \frac{- 1.5 z 0 + 2 z 1 - 0.5 z 2}{- z 0 + 2 z 1 - z 2} \qquad eq . ( 11 )$$

By multiplying 2 to the denominator and the nominator, equation (11) becomes:

$$A 2 = \frac{- 3 z 0 + 4 z 1 - z 2}{- 2 z 0 + 4 z 1 - 2 z 2} \qquad eq . ( 12 )$$

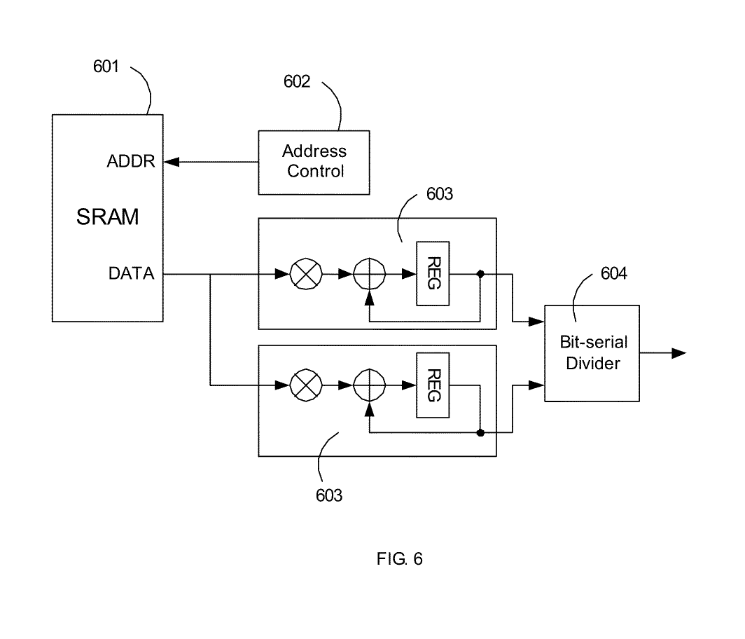

It is noted that in this step, the multiplier coefficients in eq. (12) are normalized into whole numbers. The calculation of A2 by equation (12) can easily be implemented in VLSI. One possible implementation of equation (12) is shown in FIG. 6. Referring to FIG. 6, the capacitance information array is stored in a memory device 601, for example, a Static Random Access Memory (SRAM). An address controller 602 controls the address bus of the SRAM 601 so that the data bus of the SRAM 601 outputs an element in the 1×3 matrix (z0 to z2) at each clock cycle. The data is then passed to two multiplier-accumulator (MAC) units 603 to calculate C1 and 2C2. The multiplier coefficients change among [−3, 4, −1, −2] depending on the order of the data. After three clock cycles, C1 and 2C2 are passed to a bit-serial divider 604 respectively to calculate A2. The x-coordinate of the finger touch can be obtained by POS_REF−1+A2. The number of bits of decimal part in A2 can be chosen by configuring the bit-serial divider 604, and this represents the enhancement in resolution. As an example, if 5 bits of decimal part are used, the resolution of the curve fitting is 32 times higher than the dimension of the capacitive touch panel.

In another embodiment of the present patent application, a finger touch on a capacitive touch panel forms a three-dimensional dome shaped image on the two-dimensional capacitance information array. As an example, a two-dimensional (2D) parabolic surface is chosen to fit the dome shaped profile. A simplified two-dimensional parabolic surface can be described by the following equation:

z=A0−A1(x−A2)²−A3(y−A4)² eq. (14)

The (xy) term, which is present in a standard 2D parabolic equation, is eliminated because this can further simplify some following procedures. If all of the coefficients A0, A1, A2, A3 and A4 are positive numbers, equation (14) describes a general 2D parabolic surface with a convex shape. A0 is the magnitude of the maximum point. A1 and A3 describe the falling rate on x-axis and y-axis. A2 and A4 are the x-coordinate and the y-coordinate of the maximum point respectively. After fitting the parabolic surface and obtaining A2 and A4, the coordinates of the finger touch can be found.

For the purpose of surface fitting, equation (14) has to be rearranged in a general form as shown below:

z=C0+C1x+C2y−C3x²−C4y² eq. (15)

C0 is the zero order coefficient. C1 and C2 are the first order coefficients of x-axis and y-axis respectively. C3 and C4 are the second order coefficients of x-axis and y-axis respectively. The negative sign of the second order terms is consistent with the negative sign of A1 and A3 in equation (14), which indicates the convex shape of a two-dimensional parabola.

The first step of surface fitting is to collect all data points to be fitted into equation (15), and form the following matrixes:

$$Z = [ \begin{matrix}z 0 \\ z 1 \\ z 2 \\ z 3 \\ z 4 \\ z 5 \\ z 6 \\ z 7 \\ z 8\end{matrix} ] ; \\ B = [ \begin{matrix}1 & x 0 & y 0 & - x {0}^{2} & - y {0}^{2} \\ 1 & x 1 & y 1 & - x {1}^{2} & - y {1}^{2} \\ 1 & x 2 & y 2 & - x {2}^{2} & - y {2}^{2} \\ 1 & x 3 & y 3 & - x {3}^{2} & - y {3}^{2} \\ 1 & x 4 & y 4 & - x {4}^{2} & - y {4}^{2} \\ 1 & x 5 & y 5 & - x {5}^{2} & - y {5}^{2} \\ 1 & x 6 & y 6 & - x {6}^{2} & - y {6}^{2} \\ 1 & x 7 & y 7 & - x {7}^{2} & - y {7}^{2} \\ 1 & x 8 & y 8 & - x {8}^{2} & - y {8}^{2}\end{matrix} ] ; \\ C = [ \begin{matrix}C 0 \\ C 1 \\ C 2 \\ C 3 \\ C 4\end{matrix} ] \qquad eq . ( 16 )$$

Matrix Z is a k-by-1 matrix, where k is the number of data points to be fitted. Each element in Z is the value of a data point. Matrix B, a k-by-5 matrix, is a fitting matrix, or in other words, a two-dimensional fitting array. Each row has five elements. The first element in a row is always a constant 1. The second element in a row is the x-position of the data point to be fitted. The third element in a row is the y-position of the data point to be fitted. The fourth element in a row is the negative square of the x-position of the data point to be fitted. The fifth element in a row is the negative square of the y-position of the data point to be fitted. The number of rows in B is equal to the number of data points to be fitted. Matrix C is a 5-by-1 matrix, the elements of which are C0, C1, C2, C3, and C4.

In general, the number of data points can be any number larger than or equal to 5. However, only 9 points are used in this embodiment, and therefore only 9 points are shown above.

Define a matrix E so that

E=Z−BC eq. (17)

The surface fitting problem is equivalent to finding a matrix C such that the Mean Squared Error (MSE) 1/nE^{T}E is minimal.

By substituting equation (17) into the MSE, and setting the derivative to 0, the desired C matrix can be found by the following equation:

C=[B^{T}B⁻¹B^{T}]Z eq. (18)

The matrix [B^{T}B⁻¹B^{T}] is called the pseudo-inverse of matrix B. Calculation of the pseudo-inverse inside a VLSI consumes a lot of processing power, and therefore it is avoided in this embodiment.

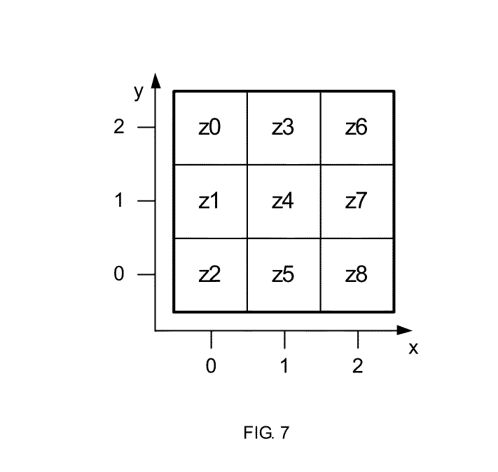

After applying the finger recognition method to the two-dimensional capacitance information array, several colonies are formed. For each validated colony, a local maximum finder searches through all the elements to locate the position of the local maximum, and store the column number and row number of that position into registers COL_REF and ROW_REF respectively. Referring to FIG. 4, for each validated colony, a 3×3 matrix is formed by the capacitance information of the 8 points surrounding the local maximum point, and the capacitance information of the local maximum point itself. Referring to FIG. 7, these nine data points are assigned with x-coordinate of [0, 1, 2] and y-coordinate of [0, 1, 2]. Putting the x and y coordinates of these nine data points into x0 to x8 and y0 to y8, B matrix can be rewritten as:

$$B = [ \begin{matrix}1 & 0 & 0 & 0 & 0 \\ 1 & 0 & 1 & 0 & - 1 \\ 1 & 0 & 2 & 0 & - 4 \\ 1 & 1 & 0 & - 1 & 0 \\ 1 & 1 & 1 & - 1 & - 1 \\ 1 & 1 & 2 & - 1 & - 4 \\ 1 & 2 & 0 & - 4 & 0 \\ 1 & 2 & 1 & - 4 & - 1 \\ 1 & 2 & 2 & - 4 & - 4\end{matrix} ] \qquad eq . ( 19 )$$

B matrix becomes a constant. The pseudo-inverse can be calculated as below:

$$[ {B}^{T} {B}^{- 1} {B}^{T} ] = [ \begin{matrix}0.556 & 0.222 & 0.222 & 0.222 & - 0.111 & - 0.111 & 0.222 & - 0.111 & - 0.111 \\ - 0.5 & - 0.5 & - 0.5 & 0.667 & 0.667 & 0.667 & - 0.167 & - 0.167 & - 0.167 \\ - 0.5 & 0.667 & 0.167 & - 0.5 & 0.667 & - 0.167 & - 0.5 & 0.667 & - 0.167 \\ - 0.167 & - 0.167 & - 0.167 & 0.333 & 0.333 & 0.333 & - 0.167 & - 0.167 & - 0.167 \\ - 0.167 & 0.333 & - 0.167 & - 0.167 & 0.333 & - 0.167 & - 0.167 & 0.333 & - 0.167\end{matrix} ] \qquad eq . ( 20 )$$

Therefore according to equation (18), C can be calculated by:

C0=0.566z0+0.222(z1+z2+z3+z6)−0.111(z4+z5+z7+z8) eq. (21)

C1=−0.5(z0+z1+z2)+0.667(z3+z4+z5)−0.167(z6+z7+z8) eq. (22)

C2=−0.5(z0+z3+z6)+0.667(z1+z4+z7)−0.167(z2+z5+z8) eq. (23)

C3=−0.167(z0+z1+z2)+0.333(z3+z4+z5)−0.167(z6+z7+z8) eq. (24)

C4=−0.167(z0+z3+z6)+0.667(z1+z4+z7)−0.167(z2+z5+z8) eq. (25)

Comparing equations (14) and (15), A2 is equal to C1/2C3, while A4 is equal to C2/2C4. Along with equations (22), (23), (24) and (25), it gives:

$$\begin{matrix}A 2 = \frac{- 0.5 ( z 0 + z 1 + z 2 ) + 0.667 ( z 3 + z 4 + z 5 ) - 0.167 ( z 6 + z 7 + z 8 )}{- 0.333 ( z 0 + z 1 + z 2 ) + 0.666 ( z 3 + z 4 + z 5 ) - 0.333 ( z 6 + z 7 + z 8 )} & eq . ( 26 ) \\ A 4 = \frac{- 0.5 ( z 0 + z 3 + z 6 ) + 0.667 ( z 1 + z 4 + z 7 ) - 0.167 ( z 2 + z 5 + z 8 )}{- 0.333 ( z 0 + z 3 + z 6 ) + 0.666 ( z 1 + z 4 + z 7 ) - 0.333 ( z 2 + z 5 + z 8 )} & eq . ( 27 )\end{matrix}$$

By multiplying 6 to the denominator and the nominator, equations (26) and (27) become:

$$\begin{matrix}A 2 = \frac{- 3 ( z 0 + z 1 + z 2 ) + 4 ( z 3 + z 4 + z 5 ) - ( z 6 + z 7 + z 8 )}{- 2 ( z 0 + z 1 + z 2 ) + 4 ( z 3 + z 4 + z 5 ) - 2 ( z 6 + z 7 + z 8 )} & eq . ( 28 ) \\ A 4 = \frac{- 3 ( z 0 + z 3 + z 6 ) + 4 ( z 1 + z 4 + z 7 ) - ( z 2 + z 5 + z 8 )}{- 2 ( z 0 + z 3 + z 6 ) + 4 ( z 1 + z 4 + z 7 ) - 2 ( z 2 + z 5 + z 8 )} & eq . ( 29 )\end{matrix}$$

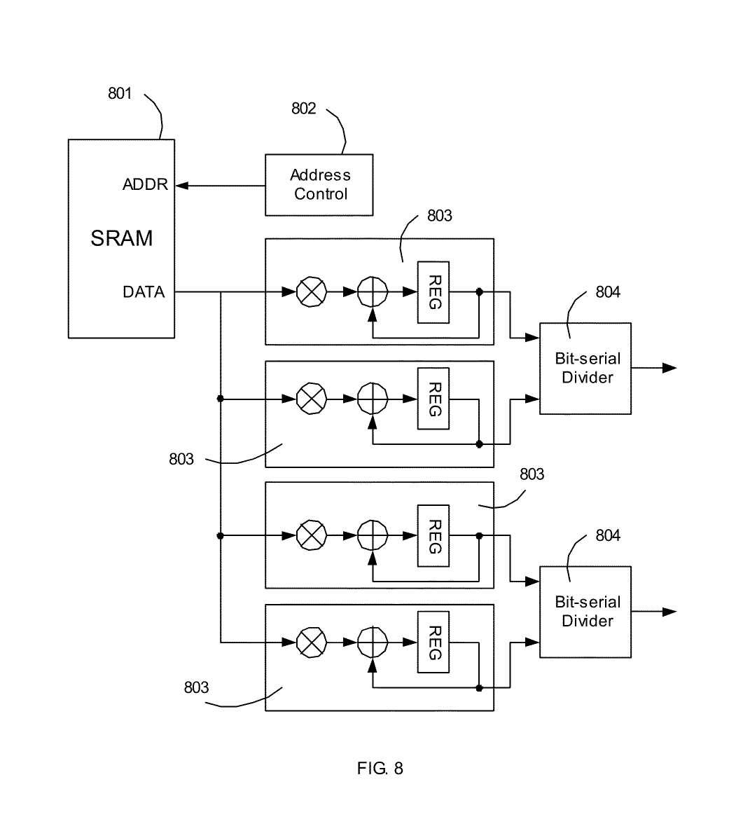

It is noted that in this step, the multiplier coefficients in eq. (29) are normalized into whole numbers. The calculation of A2 and A4 by equation (28) and (29) can be easily implemented in VLSI. One possible implementation of equation (28) and (29) is shown in FIG. 8. Referring to FIG. 8, the capacitance information array is stored in a memory device 801, for example, a Static Random Access Memory (SRAM). A address controller 802 controls the address bus of the SRAM 801 so that the data bus of the SRAM 801 outputs an element in the 3×3 matrix (z0 to z8) at each clock cycle. The data is then passed to four multiplier-accumulator (MAC) units 803 to calculate C1, C2, 2C3, and 2C4. The multiplier coefficients change among [−3, 4, −1, −2] depending on the order of the data. After nine clock cycles, C1, 2C3, and C2, 2C4 are passed to two bit-serial dividers 804 respectively to calculate A2 and A4. The x-coordinate of the finger touch can be obtained by COL_REF−1+A2, and the y-coordinate of the finger touch can be obtained by ROW_REF−1+A4. The number of bits of the decimal part in A2 and A4 can be chosen by configuring the bit-serial dividers 804, and this represents the enhancement in resolution. As an example, if 5 bits of the decimal part are used, the resolution of the surface fitting is 32 times higher than the dimension of the capacitive touch panel.

In the above embodiments for the method of resolution enhancement, in calculating the coefficients, a fixed coordinate system is applied to the elements in the fitting array so that a pseudo-inverse matrix becomes a constant. The elements in the pseudo-inverse matrix are normalized into whole numbers. In determining the positions of the touches, one coefficient is divided by another, thereby gaining resolution from the decimal precision of a divider that performs the division.

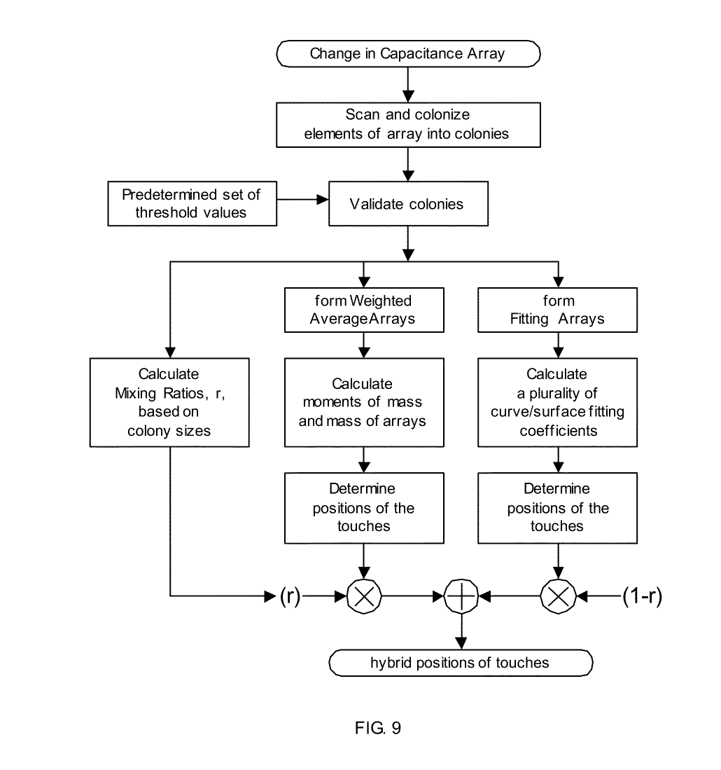

Referring to FIG. 9, in an embodiment of the present patent application, a weighted average method for determining the positions of the touches is provided. The weighted average method is similar to calculating the center of mass in physics. The weighted average method includes the following steps: using the colonized elements for each finger as a weighted average array for calculation, calculating the moments of mass and the mass of the weighted average array, and dividing the moment of mass by the mass to get the center of mass which is the finger position.

FIG. 3 shows a colonized one-dimensional array and FIG. 4 shows a colonized two-dimensional array. The shaded areas represent the colonized elements. As an example, both FIG. 3 and FIG. 4 show two colonies. The elements of a colony form a weighted average array.

The moments of mass of the weighted average array is calculated by the following equations:

Moment of Mass in X direction=Σ(element(i)×x(i))

Moment of Mass in Y direction=Σ(element(i)×y(i))

Wherein, x(i) is the distance of element(i) from a reference point in the X direction, and y(i) is the distance of element(i) from a reference point in the Y direction.

The mass of the weighted average array can be calculated by the following equation:

Mass=Σelement(i)

The center of mass or the finger position is calculated by the following equations:

$$X position = \frac{Moment of Mass in X direction}{Mass}$$

$$Y position = \frac{Moment of Mass in Y direction}{Mass}$$

Referring to FIG. 9, in one embodiment of the patent application, the weighted average method and curve fitting method are used together for resolution enhancement. A method for recognizing touches by at least a finger on a touch panel includes the following steps: calculating the colony size by counting the number of elements in the colony for each validated colony; calculating a mixing ratio, r, based on colony size for each validated colony; calculating a position of touch using the weighted average method for each validated colony; calculating a position of touch using the curve fitting method for each validated colony; calculating a hybrid position of touch by multiplying weighted average position of touch with r, multiplying curve fitting position of touch with (1−r) and adding the two products for each validated colon. The mixing ratio, r, has a value between 0 and 1. In an embodiment of the present patent application, this calculation can be implemented using a lookup table.

When finger touch areas are small, the number of colonized elements per colony is small. Weighted average calculation does not have enough data points to produce a stable and accurate finger position. When finger touch areas are large, the number of colonized elements per colony is large. Weighted average calculation has enough data points to produce a stable and accurate finger position.

When finger touch areas are small, the dome shaped profile of a finger can be distinctly represented by three elements in a one-dimensional array or represented by nine elements in a two-dimensional array. Thus, curve fitting method can produce a stable and accurate finger position. When finger touch areas are large, three elements in a one-dimensional array or nine elements in a two-dimensional array can only represent a small portion of the dome shaped profile of a finger. It is like a flat-topped profile. Thus, curve fitting method produces a less stable and accurate finger position.

The hybrid method for recognizing touches by using the weighted average and curve fitting adopts the strengths and avoids the weaknesses of both the weighted average and curve fitting. The hybrid method can provide a stable and accurate finger position regardless of the touch areas.

In another embodiment of the present patent application, a method for recognizing touches by at least a finger on a touch panel and determining the positions of the touches by analyzing a change in capacitance of electrodes of the touch panel is provided. The change in capacitance is represented as at least an array. The method includes scanning the elements of the at least one array for a predetermined number of cycles; comparing each of the elements with elements adjacent thereto in each cycle; colonizing a plurality of the elements to a colony based on the comparison; validating the colony by comparing properties of the colony with a predetermined set of threshold values; calculating a colony size by counting number of elements in the colony; calculating a mixing ratio based on colony size for each validated colony; forming a fitting array that includes the maximum element in the colony and elements adjacent to the maximum element; calculating a plurality of coefficients for a curve or a surface that fits the fitting array with a minimized mean squared error; forming a weighted average array that includes colonized elements; calculating moments of mass and mass of the weighted average array; determining second positions of the touches by dividing the moments of mass by the mass; determining hybrid positions of the touches based on the first positions, second positions and the mixing ratio so that the resolution of the determined positions is higher than the physical resolution of the touch panel.

In yet another embodiment of the present patent application, a digital signal processing unit includes logical circuits configured for recognizing touches by at least a finger on a touch panel and determining the positions of the touches by analyzing a change in capacitance of electrodes of the touch panel. The change in capacitance is represented as at least an array. The logical circuits include means for scanning the elements of the at least one array for a predetermined number of cycles; means for comparing each of the elements with elements adjacent thereto in each cycle; means for colonizing a plurality of the elements to a colony based on the comparison; means for validating the colony by comparing properties of the colony with a predetermined set of threshold values; means for calculating a colony size by counting number of elements in the colony; means for calculating a mixing ratio based on colony size for each validated colony; means for forming a fitting array that includes the maximum element in the colony and elements adjacent to the maximum element; means for calculating a plurality of coefficients for a curve or a surface that fits the fitting array with a minimized mean squared error; means for determining first positions of the touches with the coefficients; means for forming a weighted average array that includes colonized elements; means for calculating moments of mass and mass of the weighted average array; means for determining second positions of the touches by dividing the moments of mass by the mass; means for determining hybrid positions of the touches based on the first positions, second positions and the mixing ratio so that the resolution of the determined positions is higher than the physical resolution of the touch panel.

The change in capacitance may be represented as two one-dimensional arrays while the logical circuits include means for carrying out the scanning to each one-dimensional array in a forward direction and in a backward direction during alternating cycles, and means for compare each element in each one-dimensional array with two elements adjacent thereto in a predetermined order at different scan directions.

The change in capacitance may be represented as a two-dimensional array while the logical circuits include means for carrying out the scanning to the two-dimensional array in a forward direction and in a backward direction during alternating cycles, and means for comparing each element in the two-dimensional array with eight elements adjacent thereto in a predetermined order at different scan directions.

In still another embodiment of the present patent application, a touch panel includes a plurality of electrodes configured to sense touches of at least a finger on the touch panel; a digital signal processing unit configured for recognizing the touches and determining the positions of the touches by analyzing a change in capacitance of the electrodes. The change in capacitance is represented as at least an array. The digital signal processing unit includes logical circuits that include means for scanning the elements of the at least one array for a predetermined number of cycles; means for comparing each of the elements with elements adjacent thereto in each cycle; means for colonizing a plurality of the elements to a colony based on the comparison; means for validating the colony by comparing properties of the colony with a predetermined set of threshold values; means for calculating a colony size by counting number of elements in the colony; means for calculating a mixing ratio based on colony size for each validated colony; means for forming a fitting array that includes the maximum element in the colony and elements adjacent to the maximum element; means for calculating a plurality of coefficients for a curve or a surface that fits the fitting array with a minimized mean squared error; means for determining first positions of the touches with the coefficients; means for forming a weighted average array that includes colonized elements; means for calculating moments of mass and mass of the weighted average array; means for determining second positions of the touches by dividing the moments of mass by the mass; means for determining hybrid positions of the touches based on the first positions, second positions and the mixing ratio so that the resolution of the determined positions is higher than the physical resolution of the touch panel.

In calculating the coefficients, the logical circuits may include means for applying a fixed coordinate system to the elements in the fitting array so that a pseudo-inverse matrix becomes a constant. The logical circuits may include at least a divider, and means for dividing one coefficient by another with the divider, thereby gaining resolution from the decimal precision of the divider in determining the positions of the touches.

The above-mentioned embodiments of the present patent application provide an improved method to recognize finger touches and determine the positions of the finger touches while ignoring the undesired information. In response to the need of a better user experience, the method allows the possibility of recognizing more than one finger touch. Further, the method is suitable to be implemented by VLSI hardware with a small area, which fits into the compact size of modern electronic devices. Moreover, the embodiments provide an efficient algorithm so that the response to a finger touch is fast enough for the need of smooth operations.

While the present patent application has been shown and described with particular references to a number of embodiments thereof, it should be noted that various other changes or modifications may be made without departing from the scope of the present invention.

What is claimed is:

1. A method for recognizing touches by at least a finger on a touch panel and determining positions of the touches by analyzing a change in capacitance of electrodes of the touch panel, the change in capacitance being represented as at least an array, the method comprising:
scanning the elements of the at least one array for a predetermined number of cycles;
comparing each of the elements with elements adjacent thereto in each cycle;
colonizing a plurality of the elements to a colony based on the comparison;
validating the colony by comparing properties of the colony with a predetermined set of threshold values;
calculating a colony size by counting number of elements in the colony;
calculating a mixing ratio based on colony size for each validated colony;
forming a fitting array that comprises the maximum element in the colony and elements adjacent to the maximum element;
calculating a plurality of coefficients for a curve or a surface that fits the fitting array with a minimized mean squared error;
determining first positions of the touches with the coefficients;
forming a weighted average array that comprises colonized elements;
calculating moments of mass and mass of the weighted average array;
determining second positions of the touches by dividing the moments of mass by the mass; and
determining hybrid positions of the touches based on the first positions, second positions and the mixing ratio so that the resolution of the determined positions is higher than the physical resolution of the touch panel.

2. The method of claim 1, wherein the change in capacitance is represented as two one-dimensional arrays while the scanning is carried out to each one-dimensional array in a forward direction and in a backward direction during alternating cycles.

3. The method of claim 2, wherein each element in each one-dimensional array is compared with two elements adjacent thereto in a predetermined order at different scan directions.

4. The method of claim 3, wherein a plurality of elements in each one-dimensional array is grouped into a colony based on the comparison, and thereby a plurality of colonies is formed.

5. The method of claim 4, wherein the properties of the colony being compared with the predetermined set of threshold values comprise the maximum value of the elements in the colony, the number of elements of the colony, and the sum of values of all the elements of the colony.

6. The method of claim 5, wherein the step of validating the colony comprises eliminating the colony if the properties of the colony fail to meet the predetermined set of threshold values.

7. The method of claim 1, wherein the change in capacitance is represented as a two-dimensional array while the scanning is carried out to the two-dimensional array in a forward direction and in a backward direction during alternating cycles.

8. The method of claim 7, wherein each element in the two-dimensional array is compared with eight elements adjacent thereto in a predetermined order at different scan directions.

9. The method of claim 8, wherein a plurality of elements in the two-dimensional array is grouped into a colony based on the comparison, and thereby a plurality of colonies is formed.

10. The method of claim 9, wherein the properties of the colony being compared with the predetermined set of threshold values comprise the maximum value of the elements in the colony, the number of elements of the colony, and the sum of values of all the elements of the colony.

11. The method of claim 10, wherein the step of validating the colony comprises eliminating the colony if the properties of the colony fail to meet the predetermined set of threshold values.

12. The method of claim 1, wherein in calculating the coefficients, a fixed coordinate system is applied to the elements in the fitting array so that a pseudo-inverse matrix becomes a constant.

13. The method of claim 12, wherein the elements in the pseudo-inverse matrix are normalized into whole numbers.

14. The method of claim 1, wherein in determining the positions of the touches, one coefficient is divided by another, thereby gaining resolution from the decimal precision of a divider that performs the division.

15. The method of claim 1, wherein the mixing ratio has a value between 0 and 1; hybrid positions of the touches are further determined by multiplying second positions with the mixing ratio, multiplying first positions with 1-mixing ratio and adding two products together.

16. A digital signal processing unit comprising logical circuits configured for recognizing touches by at least a finger on a touch panel and determining the positions of the touches by analyzing a change in capacitance of electrodes of the touch panel, the change in capacitance being represented as at least an array; wherein:
the logical circuits comprise:
means for scanning the elements of the at least one array for a predetermined number of cycles;
means for comparing each of the elements with elements adjacent thereto in each cycle;
means for colonizing a plurality of the elements to a colony based on the comparison;
means for validating the colony by comparing properties of the colony with a predetermined set of threshold values;
means for calculating a colony size by counting number of elements in the colony;
means for calculating a mixing ratio based on colony size for each validated colony;
means for forming a fitting array that comprises the maximum element in the colony and elements adjacent to the maximum element;
means for calculating a plurality of coefficients for a curve or a surface that fits the fitting array with a minimized mean squared error;
means for determining a first positions of the touches with the coefficients;
means for forming a weighted average array that comprises colonized elements;
means for calculating moments of mass and mass of the weighted average array;
means for determining second positions of the touches by dividing the moments of mass by the mass; and
means for determining hybrid positions of the touches based on the first positions, second positions and the mixing ratio so that the resolution of the determined positions is higher than the physical resolution of the touch panel.

17. The digital signal processing unit of claim 16, wherein the change in capacitance is represented as two one-dimensional arrays while the logical circuits comprise means for carrying out the scanning to each one-dimensional array in a forward direction and in a backward direction during alternating cycles, and means for comparing each element in each one-dimensional array with two elements adjacent thereto in a predetermined order at different scan directions.

18. The digital signal processing unit of claim 16, wherein the change in capacitance is represented as a two-dimensional array while the logical circuits comprise means for carrying out the scanning to the two-dimensional array in a forward direction and in a backward direction during alternating cycles, and means for comparing each element in the two-dimensional array with eight elements adjacent thereto in a predetermined order at different scan directions.

19. A touch panel comprising:
a plurality of electrodes configured to sense touches of at least a finger on the touch panel; and
a digital signal processing unit configured for recognizing the touches and determining the positions of the touches by analyzing a change in capacitance of the electrodes, the change in capacitance being represented as at least an array; wherein:
the digital signal processing unit comprises logical circuits that comprise:
means for scanning the elements of the at least one array for a predetermined number of cycles;
means for comparing each of the elements with elements adjacent thereto in each cycle;
means for colonizing a plurality of the elements to a colony based on the comparison;
means for validating the colony by comparing properties of the colony with a predetermined set of threshold values;
means for calculating a colony size by counting number of elements in the colony;
means for calculating a mixing ratio based on colony size for each validated colony;
means for forming a fitting array that comprises the maximum element in the colony and elements adjacent to the maximum element;
means for calculating a plurality of coefficients for a curve or a surface that fits the fitting array with a minimized mean squared error;
means for determining first positions of the touches with the coefficients;
means for forming a weighted average array that comprises colonized elements;
means for calculating moments of mass and mass of the weighted average array;
means for determining second positions of the touches by dividing the moments of mass by the mass; and
means for determining hybrid positions of the touches based on the first positions, second positions and the mixing ratio so that the resolution of the determined positions is higher than the physical resolution of the touch panel.

20. The touch panel of claim 19, wherein in calculating the coefficients, the logical circuits comprise means for applying a fixed coordinate system to the elements in the fitting array so that a pseudo-inverse matrix becomes a constant.
